(19) United States
(12) Patent Application Publication
(10) Pub. No.: US 2006/0193471 A1
(43) Pub. Date: Aug. 31, 2006

(54) Encryption method and system

(76) Inventor: Jean-Luc Stehle, PARIS (FR)

Correspondence Address: FULBRIGHT & JAWORSKI, LLP, 666 FIFTH AVE, NEW YORK, NY, 10103-3198, US

(21) Appl. No.: 10/550,898

(22) PCT Filed: Mar. 25, 2004
(86) PCT No.: PCT/FR04/50127

§ 371 Date: Sep. 27, 2005

(30) Foreign Application Priority Data
Mar. 28, 2003 (FR) 03/03844

(51) Int. Cl. H04L 9/00

(52) U.S. Cl. 380/268

(57) ABSTRACT

The invention concerns an encryption method and system particularly adapted to securing email. It makes it possible to prevent the encryption of the body of a message from generating certain symbols, called control characters, that can cause undesirable phenomena during the transmission of the message. The encryption uses a pseudo-random generator, pre-initialized in a known way. The successive values provided by this generator are used to encode the successive symbols in the body of the message, any control characters present in the plaintext message being transmitted without being modified.

Securing electronic communications has become increasingly important with the growth of the Internet and its applications. The need for security goes well beyond professional communications between businesses and their clients. More generally, it includes all communications via email, including business-to-consumer communications, which must be read-protected, and more importantly, protected against any modification by unauthorized persons.

There are a number of available encryption techniques that make it possible to obtain an encrypted text which has the same length as the plaintext, and in which all of the 256 possible bytes are equiprobable, which is normally considered by cryptologists to be a necessary condition. They can be classified into two main families, block algorithms and mask algorithms.

Block algorithms divide the text into blocks of fixed length, the encryption or decryption being done block by block and resulting in a block of the same length as the input block. This is true of encryption using the DES (Data Encryption Standard) system, which uses 8-byte blocks, a standard that was accepted in the USA in 1976 and has since become the de facto worldwide standard, or AES (Advanced Encryption Standard) which uses 16-byte blocks and was selected as the new future standard by the official American agencies in 2000.

Mask algorithms consist of generating a mask of the same length as the text to be encrypted, and of applying an XOR between the text and the mask. The decryption is done by once again applying an XOR with the same mask. In this case, and hereinafter, XOR designates the “bit-by-bit exclusive OR” operation. Remember that at the bit level, applying an XOR with a bit 0 maintains the initial bit, and applying an XOR with a bit 1 inverts the initial bit. The mask is obtained, for example, by a pseudo-random generator initialized in the same way on both ends. DES encoding in the OFB mode, which has been standardized since 1980, entails using a particular pseudo-random generator that uses the DES encryption algorithm.

All of these algorithms provide encrypted texts in which all of the bytes are equiprobable.

Unfortunately, these algorithms cannot be used directly for encrypting email. In essence, the various servers and other processing devices through which emails pass on the Internet read certain bytes as control characters. These symbols can then cause undesirable behaviors, such as for example the automatic addition of a byte x0D (carriage return) whenever a byte x0A (new line) comes through unaccompanied by its x0D (carriage return), or the skipping of the rest of the message whenever a byte x00, which is read as an end-of-message, comes through. Please note: in this case, and hereinafter, xAB indicates the byte containing the number written AB in hexadecimal encoding. These disturbances render the message unreadable and impossible to decrypt on arrival.

To eliminate this drawback, certain email encryption systems group the bits into packets of 6, each of these packets being represented by a byte other than a control character. This amounts to transmitting 8 bits for every 6 useful bits, and thus increases the volume of data to be transmitted by one third.

Another solution can be implemented by using 7-bit ASCII encoding, the symbols that do not have 7-bit code (accented letters, special characters) being re-encoded into two 7-bit symbols. The transmission takes place in bytes (8 bits) in which the high-order bit is 0. If an XOR mask encryption system as described above is used, only 7 bits of the mask are used and the high-order bit, which after the application of the XOR remains at 0, is not modified. When the byte thus obtained has an undesirable value (x00, x0D, x0A, etc.), one need only artificially force its high-order bit to 1, which amounts to adding 128 to its value, prior to sending it through the network. The decryption operation is similar to the encryption: the same XOR mask is applied and the initial text is reconstituted after the high-order bit has been forced to 0.

This method solves the problem of values that may cause undesirable disturbance phenomena. However, during the transmission, it requires the use of 8 bits per symbol, where the initial message was coded in 7 bits per symbol, resulting in an increase of one-seventh of the volume of data to be transmitted. And in certain cases, the characters in which the high-order bit is 1 may cause other undesirable effects during the transmission. Generally, the main drawback of techniques of this type is that the set of symbols used by the encrypted message is different from the one used for the plaintext message, which may be detrimental for certain applications. Moreover, the use of these techniques remains limited to the case of 7-bit ASCII Encoding. These techniques are therefore incompatible with developments such as 8-bit ASCII encoding or the 16-bit Unicode encoding for handling non-Latin alphabets (Cyrillic, Greek, Arabic, Hebrew, Japanese, Chinese, etc.).

The Solution According to the Invention

Method According to the Invention

The invention concerns a method for encrypting and decrypting a piece of information. The information is represented by a string of symbols. The symbols are included in a set of symbols hereinafter called the alphabet.

The method is characterized in that it implements a pseudo-random generator. that provides a sequence of values, hereinafter called a random sequence. The values forming the random sequence are included in a set hereinafter called the random value space.

The pseudo-random generator can be initialized, prior to utilization and the provision of the random sequence, by means of a string of numbers hereinafter called the initialization key.

The initialization key determines the random sequence that will be provided by the pseudo-random generator, so that after a subsequent initialization using the same initialization key, the sequence of values provided will be the same as it was after the first initialization. The pseudo-random generator is also characterized in that the knowledge of the sequence of values provided does not make it possible to discover the initialization key within a reasonable amount of time.

The method comprises three preliminary steps.

The first preliminary step consists of dividing the alphabet into two separate parts. One of the parts is hereinafter called the control alphabet and is composed of symbols designated not to be modified during encryption; the other part is hereinafter called the message alphabet and is composed of symbols designated to be potentially modified during encryption. Thus, each of the symbols used to represent the information is included in either the control alphabet or the message alphabet; there is no symbol common to these two alphabets.

The second preliminary step consists of defining a set, called the mask alphabet, formed of all or some of the elements in the random value space.

The third preliminary step consists of assigning a permutation of the message alphabet to each element of the mask alphabet.

The three preliminary steps are performed once and for all prior to the first implementation of the method.

The implementation of the method, in order to perform the operation of encrypting a piece of information to be encrypted, comprises the following preliminary steps:

the step of acquiring a string of numbers, hereinafter called the primary encryption key,

the step of constructing the initialization key from all or part of the primary encryption key,

the step of initializing the pseudo-random generator using the initialization key.

The method consists of selecting, one after another, the symbols composing the information to be encrypted, and of encrypting each of the symbols thus selected by applying the following operations to it:

if the selected symbol belongs to the control alphabet, it is not modified;

if the selected symbol belongs to the message alphabet, the following steps are executed:

the step of reading the next value in the random sequence provided by the pseudo-random generator,

if the value read in the preceding step is not an element of the mask alphabet, the step of reiterating the preceding step until an element of the mask alphabet is obtained, the element of the mask alphabet determined in the preceding step will hereinafter be called the mask element.

The operations also comprise the following steps:

the step of selecting the permutation of the message alphabet assigned to the mask element specified in the preceding step,

the step of applying the permutation of the message alphabet selected in the preceding step to the selected symbol,

the step of replacing the selected symbol with the result of the permutation performed in the preceding step.

These operations having been executed, the method moves on to the next symbol in the information to be encrypted, and so on, until all of the symbols in the information to be encrypted have been processed.

Preferably according to the invention, the implementation of the method, in order to perform the operation of decrypting a piece of information to be decrypted, comprises the same preliminary steps as during the encryption. Thus, the pseudo-random generator is initialized in the same way as during the encryption and therefore provides the same sequence of values as during the encryption.

The method consists of selecting, one after another, the symbols composing the information to be decrypted, and of decrypting each of the symbols thus selected by applying the following operations to it:

if the selected symbol belongs to the control alphabet, it is not modified;

if the selected symbol belongs to the message alphabet, the following steps are executed:

the step of reading the next value in the random sequence provided by the pseudo-random generator,

if the value read in the preceding step is not an element of the mask alphabet, the step of reiterating the preceding step until an element of the mask alphabet is obtained.

The element of the mask alphabet determined in the preceding step will hereinafter be called the mask element.

The decryption operations comprise the following steps:

the step of selecting the inverse permutation of the permutation of the message alphabet assigned to the mask element specified in the preceding step,

the step of applying the inverse permutation selected in the preceding step to the selected symbol,

the step of replacing the selected symbol with the result of the permutation performed in the preceding step.

These operations having been executed, the method moves on to the next symbol in the information to be decrypted, and so on, until all of the symbols in the information to be decrypted have been processed.

Preferably according to the invention, the values in the random value space are numbers, so that the mask alphabet is composed of numbers. The method also includes a preliminary operation for numbering the message alphabet. The numbering consists of assigning to each symbol of the message alphabet, with no omission or repetition, a number between 0 and N-1, hereinafter called the number of the symbol, N representing the number of elements in the message alphabet, so that for any number between 0 and N-1, there is one and only one symbol of the message alphabet whose number is this number.

In this embodiment of the invention, the method- is characterized in that the result of the permutation of the message alphabet associated with a given mask element, for a given symbol belonging to the message alphabet, can be calculated by successively executing the following steps:

the step of determining the number of the given symbol,

the step of adding the given mask element to the number determined in the preceding step,

the step of calculating the remainder of the division by N of the result of the addition performed in the preceding step,

the step of determining the symbol of the message alphabet whose number is the number calculated in the preceding step; this symbol is the result that was meant to be calculated.

Hence, the permutation thus defined corresponds to a modulo-N addition on the symbol numbers, and the symbol determined in the preceding step is the result of this permutation applied to the given symbol.

Preferably according to the invention, the values in the random value space are numbers, so that the mask alphabet is composed of numbers. The method also includes a preliminary operation for numbering the message alphabet. The numbering consists of assigning to each symbol of the message alphabet, with no omission or repetition, a number between 0 and N-1, hereinafter called the number of the symbol, N representing the number of elements in the message alphabet, so that for any number between 0 and N-1, there is one and only one symbol whose number is this number.

In this variant of embodiment, the method is characterized in that the result of the permutation of the message alphabet associated with a given mask element, for a given symbol belonging to the message alphabet, can be calculated by successively executing the following steps:

the step of determining the number of the given symbol,

the step of subtracting the given mask element from the number determined in the preceding step,

when the result of the subtraction performed in the preceding step is negative, the step of adding the number N to this result as many times as necessary to obtain a positive number,

the step of calculating the remainder of the division by N of the result of the preceding step,

the step of determining the symbol of the message alphabet whose number is the number calculated in the preceding step; this symbol is the result that was meant to be calculated.

Hence, the permutation thus defined corresponds to a modulo-N subtraction on the symbol numbers, and the symbol determined in the preceding step is the result of this permutation applied to the given symbol.

Preferably according to the invention, the values in the random value space are numbers, so that the mask alphabet is composed of numbers. The method also includes a preliminary operation for numbering the message alphabet. The numbering consists of assigning to each symbol of the message alphabet, with no omission or repetition, a number between 0 and N-1, hereinafter called the number of the symbol, N representing the number of elements in the message alphabet, so that for any number between 0 and N-1, there is one and only one symbol whose number is this number.

In this variant of embodiment of the invention, the mask alphabet includes only non-zero numbers that are prime to N. The method is characterized in that the result of the permutation of the message alphabet associated with a given mask element, for a given symbol belonging to the message alphabet, can be calculated by successively executing the following steps:

the step of determining the number of the given symbol,

the step of multiplying the number determined in the preceding step by the given mask element,

the step of calculating the remainder of the division by N of the result of the multiplication performed in the preceding step,

the step of determining the symbol of the message alphabet whose number is the number calculated in the preceding step.

This symbol is the result that was meant to be calculated.

Hence, the permutation thus defined corresponds to a modulo-N multiplication on the symbol numbers, and the symbol determined in the preceding step is the result of this permutation applied to the given symbol.

Preferably according to the invention, the values in the random value space are numbers, so that the mask alphabet is composed of numbers. The method also includes a preliminary operation for numbering the message alphabet. The numbering consists of assigning to each symbol of the message alphabet, with no omission or repetition, a number between 0 and N-1, hereinafter called the number of the symbol, N representing the number of elements in the message alphabet, so that for any number between 0 and N-1, there is one and only one symbol whose number is this number.

In this variant of embodiment, the mask alphabet includes only non-zero numbers that are prime to N. The method is characterized in that the result of the permutation of the message alphabet associated with a given mask element, for a given symbol belonging to the message alphabet, can be calculated by successively executing the following steps:

the step of determining the number of the given symbol,

the step of determining a number which, when multiplied by the given mask element, differs from the number determined in the preceding step by a whole multiple of N,

the step of calculating the remainder of the division by N of the number determined in the preceding step,

the step of determining the symbol of the message alphabet whose number is the number calculated in the preceding step.

This symbol is the result that was meant to be calculated.

Hence, the permutation thus defined corresponds to a modulo-N division on the symbol numbers, and the symbol determined in the preceding step is the result of this permutation applied to the given symbol.

Preferably according to the invention, the values in the random value space are numbers, so that the mask alphabet is composed of numbers. The method also includes a preliminary operation for numbering the message alphabet. The numbering consists of assigning to each symbol of the message alphabet, with no omission or repetition, a number between 0 and N-1, hereinafter called the number of the symbol, N representing the number of elements in the message alphabet, so that for any number between 0 and N-1, there is one and only one symbol whose number is this number.

The mask alphabet includes only non-zero numbers that are prime to Phi (N), where Phi (N) designates the number of integers between 1 and N-1 that are prime to N.

In this variant of embodiment, the method is characterized in that the result of the permutation of the message alphabet associated with a given mask element, for a given symbol belonging to the message alphabet, can be calculated by successively executing the following steps:

the step of determining the number of the given symbol,

the step of calculating the remainder of the division by N of the result of the raising of the number determined in the preceding step to a power equal to the given mask element,

the step of determining the symbol of the message alphabet whose number is the number calculated in the preceding step.

This symbol is the result that was meant to be calculated. Hence, the permutation thus defined corresponds to a modular exponentiation on the symbol numbers, and the symbol determined in the preceding step is the result of this permutation applied to said given symbol.

Preferably according to the invention, the values in the random value space are numbers, so that the mask alphabet is composed of numbers. The method also includes a preliminary operation for numbering the message alphabet. The numbering consists of assigning to each symbol of the message alphabet, with no omission or repetition, a number between 0 and N-1, hereinafter called the number of the symbol, N representing the number of elements in the message alphabet, so that for any number between 0 and N-1A there is one and only one symbol whose number is this number.

The mask alphabet includes only non-zero numbers that are prime to Phi (N), where Phi (N) designates the number of integers between 1 and N-1 that are prime to N.

In this variant of embodiment, the method is characterized in that the result of the permutation of the message alphabet associated with a given mask element, for a given symbol belonging to the message alphabet, can be calculated by successively executing the following steps:

the step of determining the number of the given symbol,

the step of determining a positive number which, when raised to a power equal to the given mask element, differs from the number determined in the preceding step by a whole multiple of N,

the step of determining the remainder of the division by N of the number determined in the preceding step,

the step of determining the symbol of the message alphabet whose number is the number calculated in the preceding step.

This symbol is the result that was meant to be calculated. Hence, the permutation thus defined corresponds to a root extraction in modular arithmetic on the symbol numbers, and the symbol determined in the preceding step is the result of this permutation applied to the given symbol.

Preferably according to the invention, the method includes a preliminary operation that consists of associating each element of the mask alphabet with a quadruplet of numbers noted p, q, r and s such that the number r and the result of the expression p.s−q.r are both non-zero numbers that are not multiples of N, N representing the number of elements in the message alphabet. The method also includes a preliminary operation for numbering the message alphabet, the numbering consisting of assigning to each symbol of the message alphabet, with no omission or repetition, a number between 0 and N-1, hereinafter called the number of the symbol, so that for any number between 0 and N-1, there is one and only one symbol whose number is this number.

In this variant of embodiment, the method is characterized in that the result of the permutation of the message alphabet associated with a given mask element, for a given symbol belonging to the message alphabet, can be calculated by successively executing the following steps:

the step of determining the quadruplet of numbers p, q, r and s associated with the given mask element,

the step of determining the number of the symbol to be encrypted or decrypted; this number is hereinafter noted m,

the step of calculating the expression m.r+s,

the step, when the result of the calculation performed in the preceding step is zero or is a multiple of N, of calculating a number k such that the expression k.r−p is a multiple of N,

the step, when the result of the calculation performed in the preceding step is neither zero nor a multiple of N, of calculating a positive number k such that the expression k.(m.r+s)−(m.p+q) is a multiple of N,

the step of calculating the remainder of the division by N of the number k calculated in the preceding step,

the step of determining the symbol of the mask alphabet whose number is the number calculated in the preceding step.

This symbol is the result that was meant to be calculated. Hence, the permutation thus defined corresponds to the calculation of a homographic function in modular arithmetic on the symbol numbers, and the symbol determined in the preceding step is the result of this permutation applied to the given symbol.

Preferably according to the invention, the method implements a first pseudo-random generator that can be initialized using the initialization key. The values provided by the first pseudo-random generator are used as input data in a hash algorithm whose results are used to provide the random sequence. The pseudo-random generator consists in the composition of the first pseudo-random generator and the hash algorithm.

Preferably according to the invention, the method also includes the preliminary step of constructing, from all or part of the primary encryption key, a string of numbers hereinafter called the secondary encryption key. The method implements a first pseudo-random generator that can be initialized using the initialization key. The values provided by the first pseudo-random generator are encrypted by means of a first encryption algorithm using the secondary encryption key as the encryption key. The results of the first encryption algorithm are used to provide the random sequence.

The pseudo-random generator consists in the composition of the first pseudo-random generator and the first encryption algorithm.

System According to the Invention

The invention also concerns a system for encrypting and decrypting a piece of information. The information is represented by a string of symbols. The symbols are included in a set of symbols hereinafter called the alphabet.

The alphabet is divided into two separate parts. One of the parts is hereinafter called the control alphabet and is composed of symbols designated not to be modified during encryption; the other part is hereinafter called the message alphabet and is composed of symbols designated to be potentially modified during encryption.

The system is more particularly dedicated to securing communications between a computer, hereinafter called the client computer, and a network formed of one or more other computers; the system is interposed between the client computer and the network, so that any information running between the client computer and the network that must be encrypted or decrypted passes through the system. The system comprises a pseudo-random generator that provides a sequence of values, hereafter called a random sequence. The values forming said random sequence are included in a set hereinafter called the random value space. Some of these values are included in a subset of the random value space. This subset is hereinafter called the mask alphabet.

The pseudo-random generator can be initialized, prior to utilization and the provision of the sequence of values, by means of a string of numbers hereinafter called the initialization key. The initialization key determines the random sequence that will be provided by the generator.

The system also comprises:

two input-output units, one of which is dedicated to handling the communications between the system and the client computer, the other of which is dedicated to handling the communications between said system and said network,

first processing means that make it possible to acquire a string of numbers, hereinafter called the primary encryption key, and to construct the initialization key from all or part of the primary encryption key,

second processing means that make it possible to decide whether a value belonging to the random value space belongs to the mask alphabet,

third processing means that make it possible to read the successive values provided by the pseudo-random generator until an element belonging to the mask alphabet is obtained,

fourth processing means that make it possible to decide which of the symbols passing through said system are the symbols that must be encrypted or decrypted, and which are the symbols that must be transmitted without being modified,

fifth processing means.

These fifth processing means make it possible to select, from a given element of the mask alphabet hereinafter called the mask element, a permutation of the message alphabet. This permutation is hereinafter called the permutation assigned to the mask element.

These fifth processing means also make it possible, once the permutation assigned to the mask element has been thus selected and a given element of the message alphabet has been provided by one of the two input-output units, to determine the result of this permutation applied to said given element provided, and to send the result thus determined to the other of said two input-output units.

Preferably according to the invention, the fifth processing means also make it possible to select the inverse permutation of the permutation assigned to an element of the mask alphabet.

Preferably according to the invention, the values in the random value space being numbers, the fifth processing means also make it possible to associate a number with a symbol of the message alphabet, to perform an addition in modular arithmetic between the number and an element of the mask alphabet, and to associate the result of this addition with an element of the message alphabet.

Preferably according to the invention, the values in the random value space being numbers, the fifth processing means also make it possible to associate a number with a symbol of the message alphabet, to perform a subtraction in modular arithmetic between the number and an element of the mask alphabet, and to associate the result of this subtraction with an element of the message alphabet.

Preferably according to the invention, the values in the random value space being numbers, the fifth processing means also make it possible to associate a number with a symbol of the message alphabet, to perform a multiplication in modular arithmetic between the number and an element of the mask alphabet, and to associate the result of this multiplication with an element of the message alphabet.

Preferably according to the invention, the values in the random value space being numbers, the fifth processing means also make it possible to associate a number with a symbol of the message alphabet, to perform a division in modular arithmetic between the number and an element of the mask alphabet, and to associate the result of this division with an element of the message alphabet.

Preferably according to the invention, the values in the random value space being numbers, the fifth processing means also make it possible to associate a number with a symbol of the message alphabet, to perform an exponentiation in modular arithmetic of the number with an element of the mask alphabet as the exponent, and to associate the result of this exponentiation with an element of the message alphabet.

Preferably according to the invention, the values in the random value space being numbers, the fifth processing means also make it possible to associate a number with a symbol of the message alphabet, to perform a root extraction in modular arithmetic, and to associate the result of this root extraction with an element of the message alphabet.

Preferably according to the invention, the number of symbols composing the message alphabet hereinafter being noted N, the system also includes sixth processing means that make it possible to associate an element of the mask alphabet with a quadruplet of numbers noted p, q, r and s. The fifth processing means also make it possible:

to associate a symbol of the message alphabet with a number between 0 and N-1; this number is hereinafter noted m,

to calculate the expression m.r+s,

to determine whether the expression m.r+s is zero or a multiple of N,

to calculate a number k between 0 and N-1 such that the expression k.r−p is a multiple of N,

to calculate a number k between 0 and N-1 such that the expression k.(m.r+s)−(m.p+q) is a multiple of N,

to associate a number k thus calculated with an element of the message alphabet.

Preferably according to the invention, the system includes a first pseudo-random generator that can be initialized using the initialization key, and calculating means that make it possible, to apply a hash algorithm to the values provided by the first pseudo-random generator. The results of the hash algorithm are transmitted to the second and third processing means. The pseudo-random generator consists in the combination of the first pseudo-random generator and calculating means that make it possible to apply a hash algorithm to the values-provided by the first pseudo-random generator.

Preferably according to the invention, the system includes a first pseudo-random generator that can be initialized using the initialization key. The system also includes seventh processing means that make it possible to construct, from all or part of the primary encryption key, a string of numbers hereinafter called the secondary encryption key. The method also includes calculating means that make it possible to apply an encryption algorithm, using the secondary encryption key as the encryption key; the encryption algorithm is applied to the values provided by the first pseudo-random generator. The results of the encryption algorithm are transmitted to the second and third processing means. The pseudo-random generator consists in the combination of the first pseudo-random generator and calculating means that make it possible to apply an encryption algorithm to the values provided by the first pseudo-random generator.

### DETAILED DESCRIPTION OF THE INVENTION

The present invention concerns an encryption system wherein the encrypted text uses the same set of symbols as the plaintext message, while avoiding the undesirable disturbance effects caused by certain particular values. The encrypted text is constructed so as to have the same length as the plaintext.

Prior to the implementation of the invention, the set of symbols used is divided into two parts.

The first part, hereinafter called the control alphabet, is composed of control characters, i.e., symbols such as line breaks, carriage returns, end-of-message indicators, and more generally all of the symbols that can induce, in the various servers and other processing devices through which emails travel on the Internet, a behavior other than the simple transmission of the symbol. The control characters are transmitted unencrypted.

The second part, hereinafter called the message alphabet, is composed of all the other symbols. It is these symbols that represent the message itself.

The encryption method and system that are the subjects of the present invention implement a pseudo-random generator. This pseudo-random generator provides values included in a set of values hereinafter called the random value space. The string of values successively provided by the pseudo-random generator will hereinafter be called the random sequence.

The pseudo-random generator is initialized by means of a string of numbers called an initialization key. The random sequence provided by the pseudo-random generator depends on the initialization key, and after each initialization using the same initialization key, the same random sequence is obtained.

An encryption key, hereinafter called the primary encryption key, is used during the implementation of the encryption method and the encryption system; the knowledge of this primary encryption key subsequently makes it possible to decrypt the message that was encrypted with this key. The initialization key is determined from the encryption key. Using the same primary encryption key during decryption therefore guarantees that the random sequence used during the decryption will be the same as that used during the encryption.

Not all of the elements in the random value space are usable during encryption. A subset comprising all or some of the elements in the random value space is defined. This subset will hereinafter be called the mask alphabet, and only the elements of the mask alphabet will be used during encryption and decryption. Each element of the mask alphabet is associated with a particular permutation of the message alphabet, i.e. a one-to-one application of the message alphabet to itself. This application is used during encryption. Since it is one-to-one, two different symbols will have two different images, thus allowing an unambiguous decryption. During decryption, the reciprocal application, i.e., the inverse permutation of the permutation used during encryption, is used.

A particular embodiment of the invention that is the subject of the present patent corresponds to a particular choice among the permutations associated with the elements of the mask alphabet. Mathematically, a particular embodiment of the invention corresponds to an application of the mask alphabet to values in all of the permutations of the message alphabet.

The number of possible choices is very high. If the message alphabet is composed of N elements, there are factorial(N) different permutations of the message alphabet (where factorial(N) represents the product of the N prime integers). This number increases extremely quickly along with N. For example, for N=128, factorial(N) is a number with 215 digits in standard decimal notation.

To be more precise, the encryption operation is performed as follows. It begins by initializing the pseudo-random generator using the initialization key. Next, the information to be encrypted is read sequentially, symbol by symbol. If the symbol encountered belongs to the control alphabet, it is not modified. If it belongs to the message alphabet, the next element provided by the pseudo-random generator is read. If this element thus read does not belong to the mask alphabet, the next element provided by the pseudo-random generator is read and, if necessary, this operation is reiterated until an element of the mask alphabet, hereinafter called the mask element, is obtained. The permutation of the message alphabet associated with this mask element will then be used. This permutation, which is an application of the message alphabet to values within itself, is applied to the symbol to be encrypted, and the result takes the place of the symbol to be encrypted. These operations are reiterated for each of the symbols composing the information to be encrypted. The string of mask elements generated during these operations is called the encryption mask.

The decryption operation is done in the exact same way using, for each symbol, not the permutation associated with the mask element, but the inverse permutation of the latter. The re-initialization, prior to decryption, of the pseudo-random generator using the same initialization key used during the encryption ensures that the encryption mask used during the decryption will be the same as that used during the encryption.

To illustrate the possibilities of the invention in a nonlimiting way, let us now give a few examples of the implementation of this invention. The number N designating as before the number of symbols contained in the message alphabet, a numbering of the message alphabet—i.e., a function f that associates a symbol x of the message alphabet with a number f(x) between 0 and N-1, on a one-to-one basis—is chosen once and for all. This function will hereinafter be called the numbering function. From a mathematical point of view, the numbering function is a bijection between the message alphabet and all of the integers modulo N. The inverse function of the numbering function, i.e. the function that associates a number y between 0 and N-1 with a symbol x of the message alphabet such that f(x) is equal to y, will be called f-1.

To illustrate the possibilities of the invention in a nonlimiting way, let's describe a particular instance of such a function f in an example wherein the encoding of the symbols is done in 8-bit ASCII, i.e. in a byte, represented by a number between 0 and 255, in which the control characters are the three bytes x00, x0A and x0D represented by the numbers 0, 10 and 13. In this example, the number N of symbols contained in the message alphabet is equal to 253. The numbering function f is calculated as follows. Given a byte representing a given element of the message alphabet, we take the number x between 0 and 255 that represents it. The three operations below are then successively applied, the function Dec being the operation that consists of decrementing an integer by one unit:

Dec(x)
IF x>12 THEN Dec(x)
IF x>8 THEN Dec(x)

After these three operations are applied, the number x has a value between 0 and 252 and is the number associated by the numbering function f with the given element of the message alphabet.

In the present example, the values provided by the pseudo-random generator will be numbers, and the mask alphabet will have the same size as the message alphabet and will be composed of all of the numbers between 0 and 252. In order to precisely define the encryption system used, it would be necessary to choose 253 particular permutations of the mask alphabet from among the factorial (253)—a number with 500 digits in decimal notation−possible permutations. The number of possibilities is therefore gigantic.

To illustrate the possibilities of the invention in a nonlimiting way, let us now describe a particular choice of a permutation of the message alphabet. In this case, the choice is made to associate an element m of the mask alphabet with the permutation, i.e. the one-to-one application, that associates a number x between 0 and 252 with the remainder from 253 of the sum x+m. The permutations chosen therefore correspond to additions in modulo 253 arithmetic. Hence, the inverse permutations correspond, quite clearly, to modulo 253 subtractions.

To be very precise, once the pseudo-random generator is initialized using the initialization key, the encryption algorithm consists of selecting, one after another, the symbols composing said information to be encrypted, and of encrypting each of the symbols thus selected by applying the following operations to it:

if said selected symbol belongs to the control alphabet, it is not modified, i

f said selected symbol belong to the message alphabet, the following operations (a) through (g) are applied to it:

(a) the previously defined numbering function f is applied to the ASCII code (numbers between 0 and 255) of said selected symbol, thus providing a number x between 0 and 252;

(b) the next number provided by said pseudo-random generator is read;

(c) if the number read in the preceding step is greater than 252, the preceding operation is reiterated until a number less than or equal to 252, hereinafter noted m, is obtained;

(d) the addition y=x+m is performed;

(e) if y is greater than 252, 253 is subtracted from it;

(f) the number y now has a value between 0 and 252, and the function f-1, which is the inverse of the numbering function, is applied to it, thus providing the symbol z of the message alphabet such that f(z) is equal to y;

(g) this symbol z replaces said selected symbol of said information to be encrypted.

These operations having been executed, the method moves on to the next symbol in the information to be encrypted, and so on, until all of the symbols in the information to be encrypted have been processed.

Decryption is done in a similar fashion, after a new initialization of the pseudo-random generator using the initialization key, the operations (d) and (3) being replaced by the operations (d′) and (e′) below:

(d′) the subtraction y=x−m is performed

(e′) if y is negative, 253 is added to it.

One of the original ideas of the invention, in this particular example, consists of using the masks not with an XOR operator but with an addition in all of the integers modulo 253. But this meant first having the idea of separating the character set into two parts in order to get rid of the control characters, then the idea of applying, using the bijection f, the message alphabet to the set of integers modulo N (in this case with N=253). The innovation, in this particular embodiment, results from the juxtaposition of these three ideas. Note that the idea of modulo N addition with the elements of a mask appears, in substance, in the work of Vigenère, see for example Blaise de Vigenère's Traictè des chiffres, ou secrètes manières d'escrire, published in 1586, although modular arithmetic was completely unknown in the sixteenth century.

The use of a modular addition or a modular subtraction, described in detail in this particular example, is a simple particular implementation of the invention that is the subject of the present patent. It has been presented here in modulo N arithmetic with N=253, but it can also be implemented in a similar way for any reasonable value of N, by adapting the algorithm for calculating the numbering function f.

Addition and subtraction can be replaced by other permutations of the message alphabet.

It is possible, for example, to use modular multiplication. In that case, the operations (d) and (e) are replaced by a calculation of the product x.m (where the multiplication operation is noted by a period “.”), then of the remainder from N of the result of this multiplication. But in order for the operation thus performed to be a bijection, the number m must be prime to N. It is therefore necessary, in step (c), to reject not only the numbers greater than N, but also the number that are not prime to N.

The reciprocal operation of multiplication by m modulo N is division by m modulo N, which also requires the number m to be prime to N. The number x being known, this involves finding, in step (d), a number y such that the product y.m differs from x by a whole multiple of N. It is therefore necessary, in practice, to find two integers y and z such that y.m+N.z=x. Bezout's theorem makes it possible to prove that there is a solution for all the possible values of x whenever m is prime to N. In step (e), the remainder from N of this number y is calculated.

It is also possible to use modular exponentiation, in which case the operations (d) and (e) are replaced by the calculation of the remainder from N of the raising of x to the power m. This modular exponentiation is a bisection, and therefore allows a reciprocal operation, when the number N has no square factors and the exponent m is a non-zero number that is prime to Phi(N), where Phi (N) represents the number of integers between 1 and N-1 that are prime to N.

The reciprocal operation is the mth root extraction in modulo N arithmetic, i.e. the calculation of the remainder from N of a number y which, when raised to the power m modulo N, returns a number that differs from x by a whole multiple of N. It can be demonstrated that this operation is equivalent to raising x to a power p modulo N, where p is such that m.p−1 is a whole multiple of Phi(N). A number p that verifies this condition can be found whenever m is a non-zero number that is prime to Phi(N).

In the examples below, it is possible to discover the value of the mask element m, modulo N or modulo Phi(N) as applicable, simply by knowing the plaintext symbol and the encrypted symbol. More precisely, knowing the plaintext message and the encrypted message makes it possible to determine the mask, thus giving very strong indications on the random sequence provided by the pseudo-random generator. The number of elements in the mask alphabet is close to the number of elements in the message alphabet.

It is possible to implement the invention by choosing more sophisticated permutations, designed so that knowing a symbol in both its plaintext and encrypted form does not make it possible to precisely determine the mask element used. An example of this is provided by homographic functions. Consider the case where the number N of elements in the message alphabet is a prime number, and the mask alphabet chosen is significantly larger than the message alphabet. Ideally, the number of elements in the mask alphabet is on the order of magnitude of the cube of the number N of elements in the message alphabet, or even greater. Thus, for each element of the mask alphabet, four numbers noted p, q, r and s between 0 and N-1 are chosen such that both the number r and the result of the expression p.s−q.r are non-zero numbers that are not multiples of N. These four numbers are the 4 parameters of a homographic function in modular arithmetic, a function that will replace the one used in step (d) in the preceding examples. This fumction is the transposition in modular arithmetic of the function that, in standard arithmetic on the real numbers, is written y=(p.x+g)/(r.x+s) and whose graph is a hyperbola with asymptotes that are parallel to the coordinate axes. In standard arithmetic, all the values of y are reached once and only once, except y=p/r (which corresponds to the ordinate of the horizontal asymptote), and the function is not defined for x=−s/r, which corresponds to the abscissa of the vertical asymptote. In order for the function to become a bijection, it is advisable to give the function the value p/r when the variable x equals −s/r. To transpose the calculation of this function in modulo N arithmetic, the denominator—i.e. the expression r.x+s—is first calculated. If the result of this calculation is zero or is a multiple of N, the value y assumed by the function is a value between 0 and N-1 such that the expression r.y-p is a multiple, possibly a zero multiple, of N. In the opposite case, the value y assumed by the function is a value between 0 and N-1 such that the expression (r.x+s).y−(p.x+q) is a multiple, possibly a zero multiple, of N. The reciprocal function of this homographic function is itself a homographic function whose parameters are easy to calculate.

It is possible to develop encryption methods and systems according to the present invention using families of permutations that are much richer than in the illustrative examples presented above. It is possible, for example, to associate certain elements of the mask alphabet with modular additions, others with modular multiplications, and still others with much more complex permutations. The more complex these permutations are, the more difficult things will be for a potential hacker who wants to attack the system, but the increased security provided by far greater complexity in the permutations has its price in terms of the calculation time required to encrypt and decrypt the information.

The encryption technique presented above has the following drawback: simultaneous knowledge of the plaintext and the encrypted text makes it possible to obtain indications on the mask. In the case where an addition, a subtraction, a multiplication or a division in modular arithmetic is used, one need only know a plaintext symbol and the same symbol in encrypted form in order to immediately determine the mask element that was used to encrypt this symbol. It is not much harder in the case of modular exponentiation or root extraction. More sophisticated functions such as the homographic function make it no longer possible to precisely determine the mask, but they still provide indications that can be used by a hacker who wants to attack the system. This can be detrimental when using a pseudo-random generator of poor quality, in which case the knowledge of previously drawn random numbers can provide information on future draws. An attack of this type is called a pseudo-random generator prediction attack. Certain pseudo-random generators avoid this drawback. This is true of generators based on a block encryption algorithm used in the OFB, or “Output Feedback” mode, as described beginning on page 216 of the second French edition of Applied Cryptography by Bruce Schneier, International Thomson Publishing, France, 1997. The same is true of the method described in the patent application filed with the French Patent Office on Sep. 12, 2001 under the number FR0111776 and published on Mar. 14, 2004 under the number FR 2829643.

When the pseudo-random generator does not appear to be sufficiently protected against prediction attacks, it is possible to add an intermediate step that consists of performing various operations on the random numbers output from the random generator, in order to obtain masks such that the knowledge of them does not make it possible to obtain useful information on the random numbers that allowed them to be generated. One possible technique is to subject the random numbers output by the random generator to a one-way hash algorithm—see for example the French edition of Applied Cryptography by Bruce Schneier cited above, chapters 2.3, 2.4 and 18—the fingerprints provided by this hash then being used to generate the masks. Another possible technique consists of using an encryption algorithm that is applied to the random numbers output by the random generator, the results of which are used to generate the masks. The encryption key used for this mask generation can be calculated from the primary encryption key defined above.

### DESCRIPTION OF THE FIGURES

FIG. 1 presents the general diagram of the invention.

FIG. 2 illustrates the particular case where the pseudo-random generator GA consists in the combination of a first pseudo-random generator and a system implementing a hash algorithm.

FIG. 3 illustrates the particular case where the pseudo-random generator GA consists in the combination of a first pseudo-random generator and a system implementing an encryption algorithm.

In FIG. 1, the primary encryption key CP is used by the first processing means TRl to generate the initialization key CI. This initialization key CI is then used to initialize the pseudo-random generator GA, which provides the sequence SA whose elements will subsequently be processed sequentially. Only the elements of SA that belong to the mask alphabet will be used for encryption and decryption. The second processing means TR2 make it possible to verify whether an element of SA belongs to the mask alphabet, and the third processing means read the successive values in the random sequence SA until an element M recognized by TR2 as belonging to the mask element is obtained. This element M is called the mask M and is transmitted to the fifth processing means TR5.

The symbols S composing the information I to be encrypted or decrypted are read by means of an input-output unit UES and transmitted to the fourth processing means TR4, which make it possible to decide which symbols S are to be transmitted without being modified and which symbols S are to be encrypted or decrypted.

Given a symbol S recognized by TR4 as needing to be encrypted or decrypted, and the mask M provided by TR3, the fifth processing means TR5 calculate the permutation of the message alphabet determined by M or the inverse of this permutation, depending on whether encryption or decryption is desired, and applies it to the symbol S so as to provide as a result a symbol R, which will be transmitted by the input-output unit UES and is designated to replace the symbol S in the information I to be encrypted or decrypted.

In the case where the permutation used is a homographic function, sixth processing means TR6 are used to determine the parameters of the homographic function associated with the mask M.

In FIG. 2, the pseudo-random generator GA is composed of a first pseudo-random generator GA1 initialized by the initialization key CI, which is itself calculated by the processing means TR1 from the primary encryption key CP. The calculating means H apply a hash algorithm to the values provided by GA1, and it is the results of this hash algorithm that form the random sequence SA. The pseudo-random generator GA thus appears as the combination of GA1 and H.

In FIG. 3, the pseudo-random generator GA is composed of a first pseudo-random generator GA1 initialized by the initialization key CI, which is itself calculated by the processing means TRI from the primary encryption key CP. The calculating means K apply an encryption algorithm to the values provided by GA1, and it is the results of this encryption algorithm that form the random sequence SA. The encryption algorithm uses as the encryption key the secondary key CS, which is calculated from the primary key CP by means of the seventh processing means TR7. The pseudo-random generator GA in this case appears as the combination of GA1 and K.

1-22. (canceled)

23. A method for encrypting and decrypting information comprising a string of symbols, said symbols included in an alphabet comprising a set of symbols, the method comprising the steps of:
generating a random sequence of values using a pseudo-random generator to provide a random value space, said pseudo-random generator being initialized, prior to providing said random sequence, by an initialization key comprising a string of numbers, said initialization key determining said random sequence to be provided by said pseudo-random generator such that subsequent initialization of said pseudo-random generator using the same initialization key will result in the same random sequence of values;
dividing said alphabet into a control alphabet comprising symbols designated not to be modified during encryption, and a message alphabet comprising symbols designated to be potentially modified during encryption, such that each of said symbols used to represent said information is included in either said control alphabet or said message alphabet, there being no symbol common to both said control alphabet and said message alphabet;
defining a mask alphabet comprising all or some of the elements in said random value space, the values in said random value space being numbers such that said mask alphabet comprises numbers;
performing a numbering of said message alphabet by assigning to each symbol of said message alphabet, with no omission or repetition, a number between 0 and N-1 to provide a number for each of said symbols, N representing the number of elements in said message alphabet, such that each symbol of said message alphabet is uniquely associated with a number between 0 and N-1;
assigning a permutation of said message alphabet to each element of said mask alphabet;
acquiring a primary encryption key comprising a string of numbers; constructing said initialization key from all or part of said primary encryption key;
initializing said pseudo-random generator using said initialization key;
selecting a symbol from said information to be encrypted;
encrypting said selected symbol if it is determined that said selected symbol belongs to said message alphabet and performing the following steps:
reading the next value in said random sequence provided by said pseudo-random generator;
repeating the 'step of reading the next value until the next value read is an element of said mask alphabet to provide a mask element;
selecting permutation of said message alphabet assigned to said mask element;
applying said selected permutation of said message alphabet to said selected symbol to provide a result; and
replacing said selected symbol with said result of said selected permutation; and
repeating the steps of selecting a symbol and encrypting said selected symbol until all symbols from said information is selected.

24. The method of claim 23, further comprising the step of decrypting said information by performing the following steps:
a) selecting a symbol from said information to be decrypted;
b) determining if said selected symbol belongs to said message alphabet;
reading the next value in said random sequence provided by said random generator;
c) repeating the step of reading the next value until said mask element is obtained;
d) selecting an inverse permutation of said permutation assigned to said mask element;
e) applying said selected inverse permutation to said selected symbol to provide a result;
f) replacing said selected symbol with said result of said selected inverse permutation;
repeating the steps a)-f) until all symbols from said information is decrypted.

25. The method of claim 23, wherein the step of applying said selected permutation further comprises the steps of;
determining the number of said selected symbol;
adding said mask element to the number of said selected symbol to provide a modified symbol;
calculating a remainder by dividing said modified symbol by N; and
determining a symbol of said message alphabet whose number is said remainder, wherein said selected permutation corresponds to a modulo-N addition on the symbol numbers such that said determined symbol is a result of said selected permutation being applied to said selected symbol.

26. The method of claim 23, wherein the step of applying said selected permutation further comprises the steps of:
determining the number of said selected symbol;
subtracting said mask element from the number of said selected symbol to provide a modified symbol;
repeatedly adding, if it is determined said modified symbol is a negative number, the number N to said modified symbol until said modified symbol is a positive number;
calculating a remainder by dividing said modified symbol by N; and
determining a symbol of said message alphabet whose number is said remainder, wherein said selected permutation corresponds to a modulo-N subtraction on the symbol numbers such that said determined symbol is a result of said selected permutation being applied to said selected symbol.

27. The method of claim 23, wherein said mask alphabet comprises only non-zero numbers that are prime to N; and wherein the step of applying said selected permutation further comprises the steps of:
determining the number of said selected symbol;
multiplying the number of said selected symbol by said mask element to provide a modified symbol;
calculating a remainder by dividing said modified symbol by N; and
determining a symbol of said message alphabet whose number is said remainder, wherein said selected permutation corresponds to a modulo-N multiplication on the symbol numbers such that said determined symbol is a result of said selected permutation being applied to said selected symbol.

28. The method of claim 23, wherein said mask alphabet comprises only non-zero numbers that are prime to N; and wherein the step of applying said selected permutation further comprises the steps of:
determining the number of said selected symbol;
determining a number when multiplied by said mask element differs from the number of said selected symbol by a whole multiple of N to provide a first number;
calculating a remainder by dividing said first number by N; and
determining a symbol of said message alphabet whose number is said remainder, wherein said selected permutation corresponds to a modulo-N division on the symbol numbers such that said determined symbol is a result of said selected permutation being applied to said selected symbol.

29. The method of claim 23, wherein said mask alphabet comprises only non-zero numbers that are prime to Phi (N), where designates the number of integers between 1 and N-1 that are prime to N; and wherein the step of applying said selected permutation further comprises the steps of:
determining the number of said selected symbol;
calculating a remainder by dividing the number of said selected symbol raised to a power equal to said mask element by N; and
determining a symbol of said message alphabet whose number is said remainder, wherein said selected permutation corresponds to a modular exponentiation on the symbol numbers such that said determined symbol is a result of said selected permutation being applied to said selected symbol.

30. The method of claim 23, wherein said mask alphabet comprises only non-zero numbers that are prime to Phi (N), where designates the number of integers between 1 and N-1 that are prime to N; and wherein the step of applying said selected permutation further comprises the steps of:
determining the number of said selected symbol;
determining a positive number when raised to a power equal to said mask element differs from the number of said selected symbol by a whole multiple of N to provide a first number;
calculating a remainder by dividing said first number by N; and
determining a symbol of said message alphabet whose number is said remainder, wherein said selected permutation corresponds to a root extraction in modular arithmetic on the symbol numbers such that said determined symbol is a result of said selected permutation being applied to said selected symbol.

31. The method of claim 23, further comprising the step of associating each element of said mask alphabet with a quadruplet of numbers p, q, r and s, such that said number r and the result of the expression (p.s−q.r) are both non-zero numbers and are not multiples of N; and wherein the step of applying said selected permutation further comprises the steps of:
determining said quadruplet of numbers p, q, r and s associated said mask element;
determining a number m of a symbol to be encrypted or decrypted;
calculating a first result of the expression (m.r+s);
calculating, if it is determined that said first result is either zero or a multiple of N, a positive number k such that the expression (k.r−p) is a multiple of N;
calculating, if it is determined that said first number is neither zero nor a multiple of N, a positive number k such that the expression (k.(m.r+s)−(m.p+q)) is a multiple of N;
calculating a remainder by dividing said positive number k by N; and
determining a symbol of said mask alphabet whose number is said remainder, wherein said selected permutation corresponds to a homographic function in modular arithmetic on the symbol numbers such that said determined symbol is a result of said selected permutation being applied to said selected symbol.

32. The method of claim 23, wherein said pseudo generator comprises a first pseudo-random generator and a hash algorithm; and further comprising the steps of:
initializing said first pseudo-random generator using said initialization key; and
providing said random sequence by said hash algorithm which uses the values provided by said first pseudo-random generator as an input data.

33. The method of claim 23, wherein said pseudo generator comprises a first pseudo-random generator and an encryption algorithm; and further comprising the steps of:
constructing, from all or part of said primary encryption key, a secondary encryption key comprising a string of numbers;
initializing said first pseudo-random generator using said initialization key; and
encrypting the values provided by said first pseudo-random generator in accordance with said encryption algorithm using said secondary encryption key to provide said random sequence.

34. A system, interposed between a client computer and a network comprising one or more other computers, for encrypting and decrypting information comprising a string of symbols, said symbols included in an alphabet comprising a set of symbols, said alphabet being divided into a control alphabet comprising symbols designated not to be modified during encryption and a message alphabet comprising symbols designated to be potentially modified during encryption, each symbol belonging to said message alphabet being previously associated with a number between 0 and N-1 to provide a number for each of said symbols, N designating the number of elements in said message alphabet, such that each symbol of said message alphabet is uniquely associated with a number between 0 and N-1, the system comprising:
a pseudo-random generator for generating a random sequence of values or numbers to provide a random value space, a subset of said random value space forming a mask alphabet, said pseudo-random generator being initialized prior to utilization with an initialization key comprising a string of numbers, said initialization key determining said random sequence that will be provided by said pseudo-random generator;
an input-output unit for handling communications among the system, said client computer and said network; and
a processor for:
acquiring a primary encryption key comprising a string of numbers and constructing said initialization key from all or part of said primary encryption key;
determining whether a value belonging to said random value space belongs to said mask alphabet;
reading successive values provided by said pseudo-random generator until an element belonging to said mask alphabet is obtained;
determining which of said symbols of said information must be encrypted or decrypted, and which of said symbols of said information must be transmitted without being modified;
associating a number with a symbol of said message alphabet;
selecting a mask element from a given element of said the mask alphabet and a permutation of said message alphabet which is assigned to said mask element; and
determining a result of applying said selected permutation to said given element provided by said input-output unit and transmitting said result to said input-output unit.

35. The system of claim 34, wherein said input-output unit comprises:
a first input-output unit for handling communications between the system and said client computer; and
a second input-output unit for handling communications between the system and said network.

36. The system of claim 34, wherein said processor is operable to select an inverse permutation of said permutation assigned to said mask element.

37. The system of claim 34, wherein said processor is operable to perform an addition in modular arithmetic between said number associated with a symbol of said message alphabet and said mask element, and associate the result of said addition with an element of said message alphabet.

38. The system of claim 34, wherein said processor is operable said to perform a subtraction in modular arithmetic between said number associated with a symbol of said message alphabet and said mask element, and associate the result of said subtraction with an element of said message alphabet.

39. The system of claim 34, wherein said processor is operable to perform a multiplication in modular arithmetic between said number associated with a symbol of said message alphabet and said mask element, and associate the result of said multiplication with an element of the message alphabet.

40. The system of claim 34, wherein said processor is operable to perform a division in modular arithmetic between said number associated with a symbol of said message alphabet and said mask element, and associate the result of said division with an element of said message alphabet.

41. The system of claim 34, wherein said processor is operable to perform an exponentiation in modular arithmetic of said number associated with a symbol of said message alphabet, with said mask element as the exponent, and to associate the result of said exponentiation with an element of said message alphabet.

42. The system of claim 34, wherein said processor is operable to perform a root extraction in modular arithmetic, and associate the result of said root extraction with an element of said message alphabet.

43. The system of claim 34, wherein said message alphabet comprises N number of symbols; and wherein said processor is operable to:
associate said mask element with a quadruplet of numbers noted p, q, r and s;
associate a symbol of said message alphabet with a number m between 0 and N-1;
calculate the expression (m.r+s);
determine whether the expression (m.r+s) is zero or a multiple of N;
calculate a number k between 0 and N-1 such that the expressions (k.r−p) and (k.(m.r+s)−(m.p+q)) are multiple of N; and
associate said number k with an element of the message alphabet.

44. The system of claim 34, wherein said pseudo-random generator comprises:
a first pseudo-random generator which is initialized using said initialization key and
a calculating means for applying a hash algorithm to the values provided by said first pseudo-random generator and transmitting the result of said hash algorithm to said processor.

45. The system of claim 34, wherein said processor is operable to construct, from all or part of said primary encryption key, a secondary encryption key comprising a string of numbers; and wherein said pseudo-random generator comprises:
a first pseudo-random generator which is initialized using said initialization key and
a calculating means for applying an encryption algorithm to the values provided by said first pseudo-random generator and transmitting the result of said encryption algorithm to said processor.

46. The system of claim 34, wherein said processor comprises one or more processors to perform various tasks of said processor.
